(19) United States
(12) Patent Application Publication
(10) Pub. No.: US 2015/0255885 A1
(43) Pub. Date: Sep. 10, 2015

(54) CONNECTION TERMINAL CORE FOR CABLE CONNECTOR AND METHOD FOR CONNECTING SAID CONNECTION TERMINAL CORE FOR CABLE CONNECTOR AND SAID CABLE WITH EACH OTHER

(71) Applicant: Jong-il CHOI, (US)

(72) Inventor: Jong-il Choi, Ansan-si (KR)

(21) Appl. No.: 14/429,483

(22) PCT Filed: Sep. 17, 2013
(86) PCT No.: PCT/KR2013/008407

§ 371 Date: Mar. 19, 2015

(30) Foreign Application Priority Data
Sep. 20, 2012 (KR) 10-2012-0104829

(51) Int. Cl. H01R 4/02; H01R 43/02

(52) U.S. Cl. CPC H01R 4/023; H01R 43/02

(57) ABSTRACT

A connection terminal core for a cable connector and a method of connecting the connection terminal core to a cable. The connection terminal core includes a connection terminal portion, a terminal core body, and a lead material. When heat is applied from the outside to the terminal core body in a state in which a cable-side connection wire is inserted into a cable-side connection wire fitting hole, the heat transferred through the terminal core body melts the lead member introduced into the cable-side connection wire fitting hole, and the terminal core body and the cable-side connection wire can be bonded to each other as the lead material is melted and then is solidified again. A faulty connection is prevented, and a neat external appearance is obtained after connection.

### TECHNICAL FIELD

The present invention relates to a connection terminal core for a cable connector and a method of connecting the connection terminal core for a cable connector to a cable.

### BACKGROUND ART

A cable connector is connected to a terminal portion of a cable, and electrically connects the cable to a device to be connected, such as a closed-circuit television (CCTV), thereby enabling signals to be transferred therethrough.

A cable-side connection wire is provided inside the cable. The connection wire is formed of a copper (Cu) wire or the like, and is directly electrically connected to the device to be connected.

The core of a connection terminal for the cable connector is formed of Cu or the like, and is a component of the cable connector. The core of the connection terminal is fitted into a connection hole for the connection terminal core, the connection hole being formed in the device to be connected such that the cable can be electrically connected to the device to be connected.

The cable connector separated from the cable is carried to a site where the device to be connected is located, and subsequently is disposed at a position in which the device and the cable can be connected to each other. In this state, a length of the cable-side connection wire exposed from the terminal portion of the cable is connected to the connection terminal core, thereby connecting the cable to the cable connector.

An example of this cable connector was proposed in Korean Patent No. 10-0622056 (titled “SMALL CABLE CONNECTOR”).

In a connection terminal core for a cable connector in the related art as disclosed in this patent document, the connection terminal core is connected to a cable-side connection wire by soldering as follows: The cable-side connection wire is mechanically fitted into a cable-side connection wire fitting hole formed in the connection terminal core. In this state, the circumference of the inlet of the cable-side connection wire fitting hole is covered with a lead wire, which is then heated and solidified using a soldering iron or the like. Alternatively, lead melted using the soldering iron or the like is poured into a soldering hole formed in the connection terminal core, the soldering hole extending through the cable-side connection wire fitting hole and the outside.

However; according to this connecting method based on soldering of the related art, since the cable-side connection wire is connected to the circumference of the inlet of the cable-side connection wire fitting hole by soldering, only localized areas are connected by soldering, and the connected areas connected by soldering can be easily detached from each other. accordingly, the cable-side connection wire and the connection terminal core nay be defectively connected to each other. In addition, solidified soldering lead is disorderly placed around the inlet of the cable-side connection wire fitting hole by soldering, thereby making the appearance untidy.

In addition, according to the method of pouring previously-molten lead into tine soldering hole and solidifying the molten lead, a dedicated device for soldering, such as a soldering iron, must be prepared. It is difficult to pour the molten lead into the small soldering hole, the diameter of which is only several millimeters. Since the poured lead does not properly flow into the soldering hole, the solidified soldering lead is disorderly placed around the soldering hole, thereby making the appearance untidy. It is difficult to carry out the operation in the windy environment. Since the solidified lead remaining around the soldering hole protrudes from the surface of the connection terminal core, the connection terminal core cannot be bonded to a grounding conductor (a component of the cable connector connected to a grounding wire of the cable).

In order to overcome the above-described problems of the connecting method based on soldering of the related art, proposed was a method of connecting the cable-side connection wire to the connection terminal core by mechanically fitting the cable-side connection wire into the cable-side connection wire fitting hole and subsequently deforming the connection terminal core by pressing the connection terminal core from the outside using a tool, such as pliers. However, according to this method, the connection terminal core may be damaged, for example, broken. In addition, the contact between the connection terminal core and the cable-side connection wire is limited to localized areas, thereby causing the problem of poor contact with the lapse of time.

### DISCLOSURE

### Technical Problem

An object of the present, invention provides a connection terminal core for a cable connector, in which the connection terminal core can be firmly and tidily connected to a cable-side connection, wire by soldering while allowing the soldering operation to be simply carried out, and a method of connecting the connection terminal core for a cable connector to a cable.

### Technical Solution

In an aspect of the present invention, provided is a connection terminal core for a cable connector. The connection terminal core is a component of the cable connector that is connected to a terminal portion of a cable provided therein with a cable-side connection wire to be electrically connected to a device to be connected, allowing the cable-side connection wire to be electrically connected to the device to be connected. The connection terminal core is fitted into a connection hole for the connection terminal core formed in the device to be connected such that the cable is electrically connected to the device to be connected.

The connection terminal core includes: a connection terminal portion configured to be fitted into the connection hole for the connection terminal core; a terminal core body connected to the connection terminal portion, and having a fitting hole .into which the cable-side connection wire is to be fitted; and a solid lead material introduced into the terminal core body.

When external heat is applied to the terminal core body in a state in which the cable-side connection wire is fitted into the fitting hole, the neat transferred through the terminal core body melts the lead material introduced into the fitting hole, such that the terminal core body and the cable-side connection wire are bonded to each other as the molten lead material is solidified again

In the state in which the lead material melted by the heat transferred through the terminal core body thermally expands and fills a space between the cable-side connection wire and an inner wall of the fitting hole, the lead material may be solidified, such that the cable-side connection wire and the inner wall of the connection wire fitting hole are firmly bonded to each other by means of the lead material.

In another aspect of the present invention, provided is a method of connecting a connection terminal core for a cable connector to a cable. The connection terminal core is a component of the cable connector that is connected to a terminal portion of a cable provided therein with a cable-side connection wire to be electrically connected to a device to be connected, allowing the cable-side connection wire to be electrically connected to the device to be connected. The connection terminal core being fitted into a connection hole for the connection terminal core formed in the device to be connected such that the cable is electrically connected to the device to be connected. The connection terminal core includes a connection terminal portion configured to be fitted into the connection hole for the connection terminal, core, a terminal core body connected to the connection, terminal portion, and having a fitting hole into which the cable-side connection wire is to be fitted, and a solid lead material introduced into the terminal core body.

The method includes: step (a) of fitting the cable-side connecting wire into the fitting hole; step (b) of applying external heat to the terminal core body in a state in which the cable-side connecting wire is fitted into the fitting hole such that the lead material introduced into the fitting hole is melted by the heat transferred through the terminal core body; and step (c) of solidifying the lead material again such that the terminal core body and the cable-side connecting wire are bonded to each other while the molten lead material is being solidified.

The lead material melted by the heat transferred through the terminal core body may thermally expand and fill a space between the cable-side connecting wire and an inner wall of the fitting hole at the step (b), and subsequently may be solidified again at the step (c), such that the cable-side connecting wire and the inner wall of the fitting hole are bonded to each other by means of the lead material.

### Advantageous Effects

According to the connection terminal core for a cable connector and the method of connecting the connection terminal core for a cable connector to a cable of the present invention, in the state in which the lead material in the solid state is introduced into the terminal core body and the cable-side connection wire is fitted into the connection wire fitting hole, external heat is transferred to the terminal core body through the terminal core body, subsequently melting the lead material introduced into the connection wire fitting hole. The molten lead material thermally expands, thereby filling the space between the cable-side connection wire and the inner wall of the connection wire fitting hole. In this state, the molten lead material is solidified again, firmly bonding the terminal core body and the cable-side connection wire to each other. Since the connection wire fitting hole and the cable-side connection wire can be bonded to each other by means of the lead material that has spread in the entire space between the connection wire fitting hole and the cable-side connection wire, the cable connection terminal core and the cable-side connection wire can be firmly bonded to each other, thereby preventing a defect in connection. Since the lead material is not exposed around the inlet of the connection wire fitting hole, the bonded structure can have a tidy appearance. It is possible to perform the soldering operation using a surrounding heat source, such as a lighter, without having to use a dedicated device, such as a soldering iron. It is required to neither cover the connected portions with lead nor inject molten lead into a soldering hole at a site. Thus, the operation of connecting the cable connection terminal core and the cable-side connection wire to each other can be simply carried out. Accordingly, the safety of a worker who must work in a harsh environment, such as on a ladder or a scaffold, can be improved. It is possible to carry out the operation in the windy environment.

### DESCRIPTION OF DRAWINGS

FIG. 1 is a perspective view illustrating a connect ion terminal core for a cable connector according to an exemplary embodiment of the present invention;

FIG. 2 is a cross-sectional view illustrating the connection terminal core for a cable connector according to an exemplary embodiment of the present invention before being connected to a cable-side connection wire of a cable;

FIG. 3 is a cross-sectional view illustrating the connection terminal core for a cable connector according to an exemplary embodiment of the present invention into which the cable-side connection wire of the cable is fitted;

FIG. 4 is an enlarged view illustrating the part A of FIG. 3;

FIG. 5 is a cross-sectional view illustrating a shape in which a heated lead material inside the connection terminal core for a cable connector according to an exemplary embodiment of the present invention has spread through thermal expansion, filling the space between the inner surface of the connection terminal core for a cable connector and the cable-side connection wire; and

FIG. 6 is an enlarged view illustrating the part B of FIG.

### BEST MODE

Reference will now be made to a connection terminal core for a cable connector and a method of connecting a connection terminal core for a cable connector to a cable according to embodiments of the present invention in conjunction with the accompanying drawings.

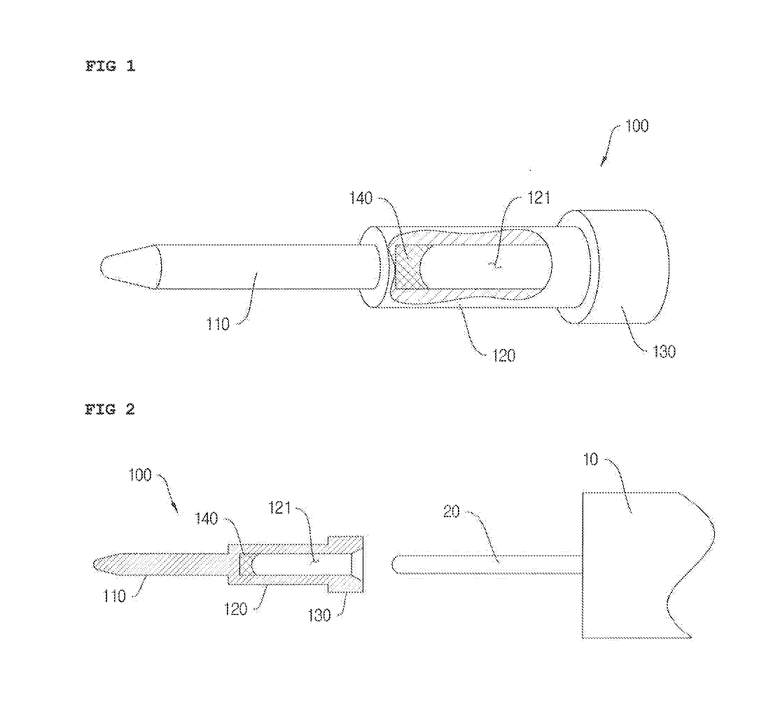

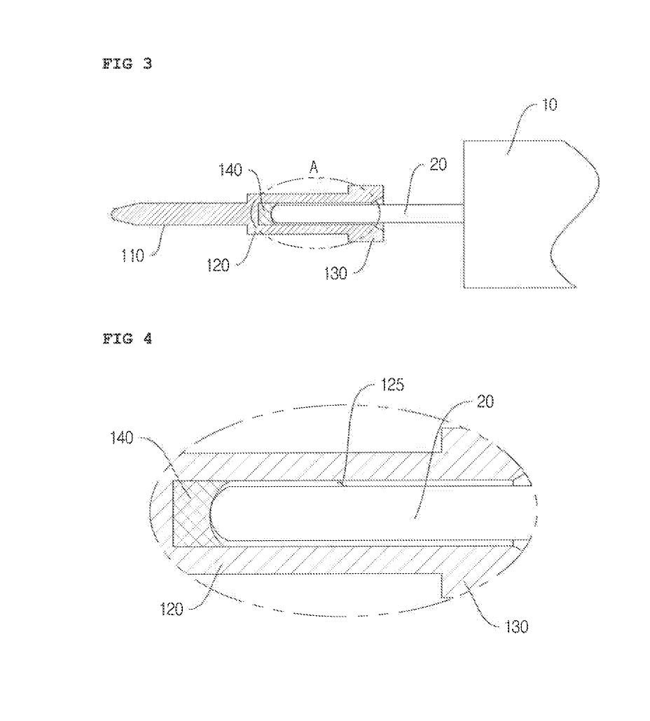

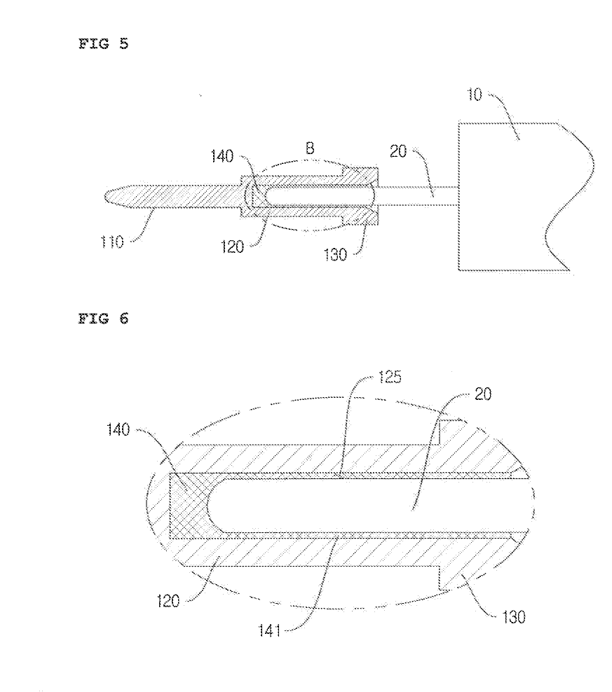

FIG. 1 is a perspective view illustrating a connection terminal core for a cable connector according to an exemplary embodiment of the present invention, FIG. 2 is a cross-sectional view illustrating the connection terminal core for a cable connector according to an exemplary embodiment of the present invention before being connected to a cable-side connection wire of a cable, FIG. 3 is a cross-sectional view illustrating the connection terminal core for a cable connector according to an exemplary embodiment of the present invention into which the cable-side connection wire of the cable is fitted, FIG. 4 is an enlarged view illustrating the part A of FIG. 3, FIG. 5 is a cross-sectional view illustrating a shape in which a heated lead material inside the connection terminal core for a cable connector according to an exemplary embodiment of the present invention has spread through thermal expansion filling the space between the inner surface of the connection terminal core for a cable connector and the cable-side connection wire, and FIG. 6 is an enlarged view illustrating the part B of FIG. 5.

Referring to FIG. 1 to FIG. 6, the connection terminal core tor a cable connector (hereinafter referred to as the “cable connection terminal core”) 100 includes a connection terminal portion 110, a terminal core body 120, and a lead material 140. The cable connection terminal core 100 is a component for a cable connector that can be connected to a terminal portion of a cable 10 provided therein with a cable-side connection wire 20 to be electrically connected to a device to be connected, thereby connecting the cable 10 to the device to be connected. The cable connection terminal core 100 is to be fitted into a connection hole (not shown) for the connection terminal core, the connection hole being formed in the device to be connected such that the cable 10 cam be electrically connected to the device to be connected.

The cable connector includes the cable connection terminal core 100 and a grounding conductor connected to a grounding wire of the cable 10. Since the grounding conductor is typical in the field of cables such as coaxial cables, a detailed description thereof will be omitted.

The tip portion of the connection terminal portion 110 is tapered such that the connection terminal portion 110 is directly fitted into the connection hole of the device to be connected in a mechanical manner.

The terminal core body 120 is connected to and extends backward from the connection terminal portion 110, and is provided therein with a cable-side connection wire fitting hole (hereinafter referred to as a “connection wire fitting hole”) 121 into which the cable-side connection wire 20 can be fitted.

The diameter of the terminal core body 120 is greater than the diameter of the connection terminal portion 110 such that a stepped portion is formed on a portion where the connection terminal portion 110 is connected to the terminal core body 120.

The connection wire fitting hole 121 is shaped as a pit excavated into the terminal core body 120 from the backward of the terminal core body 120.

The connection terminal portion 110 and the terminal core body 120 are formed of a metal material, such as copper (Cu), in order to facilitate electrical conduction.

A catch portion 130 is formed on a terminal portion of the terminal core body 120. The diameter of the catch portion 130 is greater than the diameter of the terminal core body 120 such that the cable connection terminal core 100 can be caught by the grounding conductor or the like.

According to this embodiment, the lead material 140 in the solid state is introduced into the connection wire fitting hole 121 of the terminal core body 120. The lead material 140 may be formed of a typical lead component used in soldering, and can be introduced into and stay in the deepest position of the connection wire fitting hole 121.

With this configuration, when external neat is applied to the terminal core body 120 in the state in which the cable-side connection wire 20 is mechanically fitted into the connection wire fitting hole 121, the heat is transferred through the terminal core body 120, thereby melting the lead material 140 introduced into the connection wire fitting hole 121. As the molten lead material 140 is solidified again, the terminal core body 120 and the cable-side connection wire 20 can be firmly bonded to each other.

The lead material 140 melted by the heat transferred through. the terminal core body 120 thermally expands. Consequently, the thermally-expanded lead material 140 fills a space 125 between the cable-side connection wire 20 and the inner wall of the connection wire fitting hole 121 (see reference numeral 141 in FIG. 6). As the lead material 140 is solidified, in this state, the cable-side connection wire 20 and the inner wall of the connection wire fitting hole 121 can be firmly bonded to each other by means of the lead material 140.

A heat source for heating the terminal core body 120 is only required to heat the terminal core body 120 from the outside. Thus, a variety of heat sources easily attainable from the surroundings, such as a lighter carried by a worker, can be used instead of a dedicated device, such as a soldering iron.

A method of connecting the cable connection terminal core 100 according to this embodiment to the cable 10 includes: (a) step of fitting the cable-side connection wire 20 into the connection wire fitting hole 121; (b) step of applying external, heat to the terminal core body 120 in the state in which the cable-side connection wire 20 is fitted into the connection wire fitting hole 121 such that the lead material 140 introduced into the connection wire fitting hole 121 can be melted by the heat transferred through the terminal core body 120; and (c) solidifying the lead material 140 again such that the terminal core body 120 and the cable-side connection wire 20 are bonded to each other while the molten lead material 140 is being solidified.

Here, the lead. material 140 melted by the heat transferred through the terminal core body 120 may thermally expand and fill the space 125 between the cable-side connection wire 20 and the inner wall of the connection wire fitting hole 121 at the (b) step, and subsequently may be solidified again at the (c) step, such that the cable-side connection wire 20 and the inner wall of the connection wire fitting hole 121 can also be bonded to each other by means of the lead material 140.

As set forth above, in the state in which the lead material 140 in the solid state is introduced into the terminal core body 120 and the cable-side connection wire 20 is fitted into the connection wire fitting hole 121, external heat is transferred to the terminal core body 120 through the terminal core body 120, subsequently melting the lead material 140 introduced into the connection wire fitting hole 121. The molten lead material 140 thermally expands, thereby filling the space 125 between the cable-side connection wire 20 and the inner wall of the connection wire fitting hole 121. In this state, the molten lead material 140 is solidified again, firmly bonding the terminal core body 120 and the cable-side connection wire 20 to each other. Since the connection wire fitting hole 121 and the cable-side connection wire 20 can be bonded to each other by means of the lead material 140 that has spread in the entire space between the connection wire fitting hole 121 and the cable-side connection wire 20, the cable connection terminal core 100 and the cable-side connection wire 20 can be firmly bonded to each other, thereby preventing a defect in connection. Since the lead material 140 is not exposed around the inlet of the connection wire fitting hole 121, the bonded structure can have a tidy appearance. It is possible to perform the soldering operation using a surrounding heat source, such as a lighter, without having to use a dedicated device, such as a soldering iron. It is required to neither cover the connected portions with lead nor inject molten lead into a soldering hole at a site. Thus, the operation of connecting the cable connection terminal core 100 and the cable-side connection wire 20 to each other can be simply carried out. Accordingly, the safety of a worker who must work in a harsh environment, such as on a ladder or a scaffold, can be improved. It is possible to carry out the operation in the windy environment.

While the present invention has been shown and described with reference to the certain exemplary embodiments thereof, it will be understood by a person skilled in the art that various changes and variations may be made therein without departing from the spirit and scope of the present invention as defined by the appended claims and their equivalents. It should be understood, however, that all such changes and variations fail within the scope of the present invention.

### INDUSTRIAL APPLICABILITY

According to the connection terminal core for a cable connector and the method of connecting the connection terminal core for a cable connector to a cable of the present invention, the connection terminal core can be firmly and tidily connected to the cable-side connection wire by soldering while allowing the soldering operation to be simply carried out. Therefore, the present invention has high industrial applicability.

1. A connection terminal core for a cable connector, in which the connection terminal core comprises a component of the cable connector that is connected to a terminal portion of a cable provided therein with a cable-side connection wire to be electrically connected to a device to be connected, allowing the cable-side connection wire to be electrically connected to the device to be connected, the connection terminal core being fitted into a connection hole for the connection terminal core formed in the device to be connected such, that the cable is electrically connected to the device to be connected, the connection terminal core comprising:
a connection terminal portion configured to be fitted into the connection hole for the connection terminal core;
a terminal core body connected to the connection terminal portion, and having a fitting hole into which the cable-side connection wire is to be fitted; and
a solid lead material introduced into the terminal core body,
wherein, when external heat is applied to the terminal core body in a state in. which the cable-side connection wire is fitted into the fitting hole, the heat transferred through the terminal core body melts the lead material introduced into the fitting hole, such that the terminal core body and the cable-side connection wire are bonded to each other as the molten lead material is solidified again.

2. The connection terminal core according to claim 1, wherein, in a state in which the lead material melted by the heat transferred through the terminal core body thermally expands and fills a space between the cable-side connection wire and an inner wall of the fitting hole, the lead material is solidified, such that the cable-side connection wire and the inner wall of the connection wire fitting hole are firmly bonded to each other by means of the lead material.

3. A method of connecting a connection terminal core for a cable connector to a cable, in which the connection terminal core comprises a component of the cable connector that is connected to a terminal portion of a cable provided therein, with a cable-side connection wire to be electrically connected to a device to be connected, allowing the cable-side connection wire to be electrically connected to the device to be connected, the connection terminal core being fitted into a connection hole for the connection terminal core formed in the device to be connected such that the cable is electrically connected to the device to be connected, the connection terminal core comprising a connection terminal portion configured to be fitted into the connection hole for the connection terminal core, a terminal core body connected to the connection terminal portion, and having a fitting hole into which the cable-side connection wire is to be fitted, and a solid lead material introduced into the terminal core body, the method comprising:
(a) fitting the cable-side connecting wire into the fitting hole;
(b) applying external heat to the terminal core body in a state in which the cable-side connecting wire is fitted into the fitting hole such that the lead material introduced into the fitting hole is melted by the heat transferred through the terminal core body; and
(c) solidifying the lead material again such that the terminal core body and the cable-side connecting wire are bonded to each other while the molten lead material is being solidified.

4. The method according to claim 3, wherein the lead material melted by the heat transferred through the terminal core body thermally expands and fills a space between the cable-side connecting wire and an inner wall of the fitting hole at the process (b), and subsequently is solidified again at the process (c), such that the cable-side connecting wire and the inner wall of the fitting hole are bonded to each other by means of the lead material.
